(19) United States
(12) Patent Application Publication
(10) Pub. No.: US 2025/0207421 A1
(43) Pub. Date: Jun. 26, 2025

(54) SWIMMING POOL OR SPA WITH LOCALIZED HEATING

(71) Applicant: ZODIAC POOL CARE EUROPE, Belberaud (FR)

(72) Inventor: Simon Duffaut, Castelginest (FR)

(73) Assignee: ZODIAC POOL CARE EUROPE, Belberaud (FR)

(21) Appl. No.: 18/989,202

(22) Filed: Dec. 20, 2024

Related U.S. Application Data
(60) Provisional application No. 63/614,496, filed on Dec. 22, 2023.

(51) Int. Cl. E04H 4/12; A61H 33/00

(52) U.S. Cl. CPC E04H 4/129; A61H 33/005; E04H 4/1245; A61H 2033/0058; A61H 2201/0207; A61H 2201/0242

(57) ABSTRACT

A system and method are provided for locally heating a sub-portion of a swimming pool or spa. The method may include controlling operation of a pump and a heater of the circulation to be in a spa mode. Controlling operation of the pump may include decreasing a flow of water through a circulation system using the pump. Controlling operation of the heater may include increasing a temperature of water flowing through the circulation system using a heater.

### REFERENCE TO RELATED APPLICATION

This application claims the benefit of and priority to U.S. Provisional Patent Application No. 63/614,496, filed on Dec. 22, 2023, and entitled SWIMMING POOL OR SPA WITH LOCALIZED HEATING, the content of which is hereby incorporated by reference in its entirety.

### FIELD OF THE INVENTION

The invention relates to swimming pools and spas, and more particularly, although not necessarily exclusively, to systems and methods for heating water of the swimming pool or spa.

### BACKGROUND OF THE INVENTION

Swimming pools and spas are commonly used for a variety of recreational and other purposes, and in some cases, it may be desirable to heat the water of the swimming pool or spa. Traditional approaches to heating swimming pools or spas utilize heat pumps or other heating equipment which heat the entire swimming pool. However, such traditional approaches may be time consuming and may consume excessive amounts of energy and may be wasteful from both a resource perspective and a financial perspective. As an example, while traditional approaches heat the entire pool, a user of the pool may only be interested in occupying a portion of the pool.

### SUMMARY

Embodiments covered by this patent are defined by the claims below, not this summary. This summary is a high-level overview of various embodiments and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to some embodiments, a method of locally heating a sub-portion of a swimming pool or spa includes decreasing a flow of water through a circulation system using a pump and increasing a temperature of water flowing through the circulation system using a heater.

According to various embodiments, a method of establishing a temperature gradient in water of a swimming pool or spa includes operating a heater at an increased temperature relative to a temperature baseline and operating a filtration pump at a decreased speed relative to a flow baseline.

According to certain embodiments, a method of locally heating a sub-portion of a swimming pool or spa includes receiving an activation signal from a user and changing a mode of a heater and a pump from a base mode to a spa mode. In certain cases, in the spa mode, the heater heats water of the swimming pool or spa with higher power compared to the base mode and the pump decreases a flow of water compared to the base mode.

According to some embodiments, a circulation system for a swimming pool or spa includes an inlet for receiving water from the swimming pool or spa, a heater, a pump, and an outlet. In various embodiments, in a spa mode, the circulation system decreases a flow of water and increases a temperature of the water.

According to various embodiments, non-transitory computer readable storage medium comprising a plurality of instructions executable by one or more processors, which, when executed on the one or more processors, cause the one or more processors to perform actions including locally heating a sub-portion of a swimming pool or spa and/or establishing a temperature gradient in water of a swimming pool or spa.

According to certain embodiments, non-transitory computer readable storage medium comprising a plurality of instructions executable by one or more processors, which, when executed on the one or more processors, cause the one or more processors to perform actions including receiving an activation signal from a user and changing a mode of a heater and a pump from a base mode to a spa mode. In some cases, in the spa mode, the heater heats water of the swimming pool or spa with higher power compared to the base mode and the pump decreases a flow of water compared to the base mode.

Various implementations described herein can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The specification makes reference to the following appended figures, in which use of like reference numerals in different FIGURES is intended to illustrate like or analogous components.

FIG. 1 illustrates an example of a pool system according to embodiments.

### DESCRIPTION OF THE INVENTION

Described herein are systems and methods for locally heating a sub-portion of a swimming pool or spa and/or for creating a temperature gradient within the swimming pool or spa. As used herein, a “sub-portion” of the swimming pool or spa refers to less than the entire volume of the swimming pool or spa. The systems and methods described herein may provide energy and cost savings by heating an area of interest within the pool for a user. In certain embodiments, the systems and methods described herein may allow for rapid or quick heating of the sub-portion of the swimming pool or spa. In some embodiments, the systems and methods described herein may locally heat the sub-portion of the swimming pool or spa and/or create the temperature gradient by decreasing a flow of water through a circulation system of the swimming pool or spa and increasing heating performance of a heater of the circulation system.

In some embodiments, the systems and methods described herein may be operable in both a base mode and a spa mode. In the base mode, the flow of water and heating performance may be controlled such that substantially the entire pool is heated, and in the spa mode, the flow of water and heating performance may be controlled such that only the sub-portion of the pool is heated and/or only the sub-portion is actively heated. Optionally, the spa mode may be established by a user while the user is remote from the pool. Various other benefits and advantages may be realized with the systems and methods provided herein, and the aforementioned advantages should not be considered limiting.

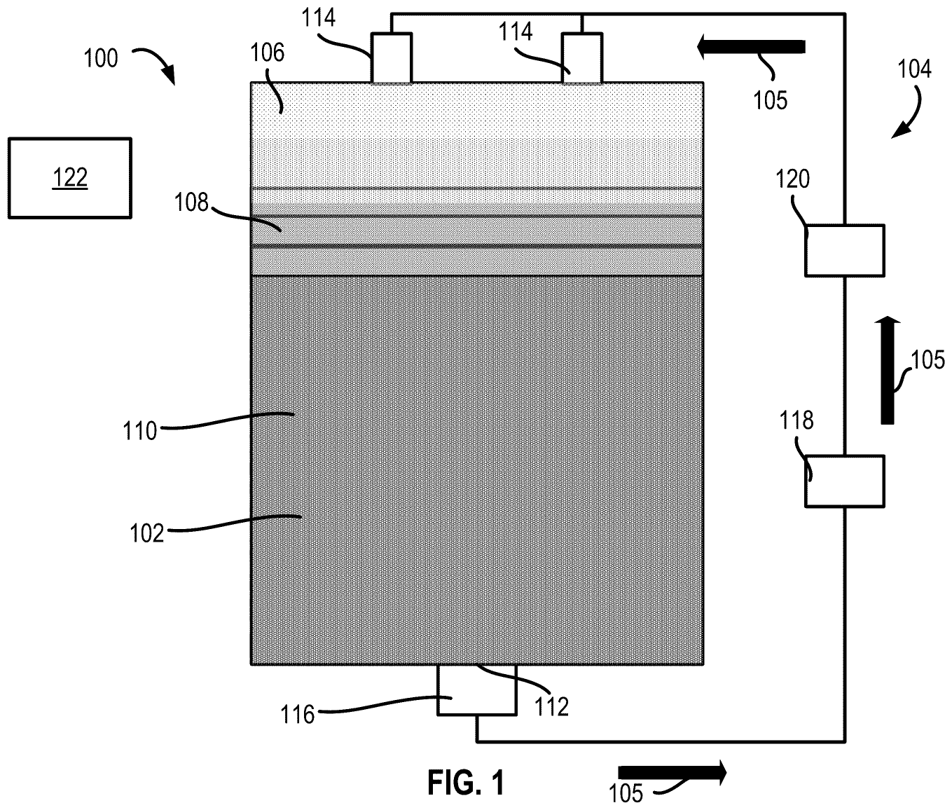

FIG. 1 illustrates an example of a pool system 100 according to embodiments. The pool system 100 generally includes a pool 102 and a circulation system 104.

The pool 102 may have various features, arrangements, shapes, and profiles as desired. As non-limiting examples, the pool 102 may have a beach 106, stairs 108, a deep side 110, sub-combinations thereof, and/or other features in various arrangements. In another non-limiting example, the pool 102 may omit the stairs 108, omit the beach 106, include a feature such as a submerged bench, and/or other arrangements. As such, the particular pool 102 illustrated in FIG. 1 should not be considered limiting.

The circulation system 104 generally includes one or more inlets 112 for receiving water from the pool 102 and one or more outlets 114 for directing circulated water back into the pool 102. The number and location of the inlets 112 and/or the outlets 114 should not be considered limiting on the disclosure. The flow of water through the circulation system 104 is represented by arrows 105.

In addition to the inlets 112 and the outlets 114, the circulation system 104 may include various equipment or components for performing various operations. Non-limiting examples of equipment of the circulation system 104 may include, but are not limited to, one or more skimmers 116, one or more filtration systems or filters, one or more pumps 118, one or more heaters 120, one or more sanitation systems, sub-combinations thereof, and/or other equipment. In certain embodiments, the circulation system 104 includes at least one pump 118 and at least one heater 120.

The pump 118 may control a flow rate of water flowing through the circulation system 104 back to the pool 102 and may be any suitable type of pumps 118. In one non-limiting example, the pump 118 may be a filtration pump. In certain embodiments, the pump 118 may be operable in various modes such that the water may flow at various flow rates. In some non-limiting examples, the pump 118 may be operable in at least a base mode and a spa mode, and in the spa mode, the flow rate is less than the flow rate of water when the pump is in the base mode.

The heater 120 may control a temperature of water flowing through the circulation system 104 back to the pool 102 and may be various types of heaters 120. In one non-limiting example, the heater 120 may be a heat pump. Similar to the pump 118, the heater 120 may be operable in various modes for heating the water. In some non-limiting examples, the heater 120 may be operable in at least a base mode and a spa mode, and in the spa mode, the heater 120 heats the water to a higher temperature (e.g., by operating at a higher power or otherwise) compared to the base mode.

Optionally, the circulation system 104 includes one or more controllers 122 (processing unit and/or memory device) communicatively coupled to one or more pieces of equipment of the circulation system 104 using various communication techniques as desired. The processing unit of the controller may be any suitable processing device or combinations of devices including but not limited to one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units, and/or a combination thereof. The one or more memory devices of the controller 122 may be any machine-readable medium that can be accessed by the processor, including but not limited to any type of long term, short term, volatile, nonvolatile, or other storage medium, and is not to be limited to any particular type of memory or number of memories, or type of media upon which memory is stored. Moreover, as disclosed herein, the term “storage medium,” “storage” or “memory” can represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to, portable or fixed storage devices, optical storage devices, wireless channels, and/or various other storage mediums capable of storing that contain or carry instruction(s) and/or data.

In certain embodiments, the controller 122 optionally includes an associated user interface, including but not limited to a human machine user interface, such that the controller 122 may obtain information from a user and/or provide information to the user via the user interface. When included, the user interface may be on the controller 122 itself or may be at a location remote from the controller 122 such as, but not limited to, another location within the pool system 100. Additionally, or alternatively, the controller 122 optionally may include one or more communication modules such that the controller 122 may receive and/or send information to a user device and/or other location. Non-limiting examples of communication modules may include systems and mechanisms enabling wired communication and/or wireless communication (e.g., near field, cellular, Wi-Fi, Bluetooth®, Bluetooth Low Energy (BLE), low-power wide area network, cloud-based communication etc.). In one non-limiting example, the controller 122 may receive and/or send information to a user device via an application running on the user device.

In various embodiments, the pool system 100 is controlled such that a sub-portion of the pool 102 is heated and/or a temperature gradient is established in the pool 102. In the non-limiting example shown in FIG. 1, and as represented by the heat map, the beach 106 and stairs 108 area of the pool 102 are locally heated while the deep side 110 is not. In certain embodiments, the portion of the pool 102 locally heated may be proximate to the one or more outlets 114.

In some embodiments, the sub-portion of the pool 102 is locally heated by operating and/or activating the pump 118 and/or the heater 120 to be in the spa mode. As previously mentioned, in the spa mode, the pump 118 reduces the flow rate of the water through the circulation system 104 and the heater 120 heats with a higher power and/or increases the temperature to which the water of the circulation system 104 is heated. In the spa mode, the water relayed by the circulation system 104 in the pool 102 may reach an elevated temperature more quickly and may generally be concentrated in an area close to the outlet 114 and/or within the desired sub-region. Optionally, where a plurality of outlet 114 are included, locally heating a sub-portion of the pool 102 may further include controlling the outlets 114 through which the heated water is dispersed back into the pool 102. As a non-limiting example, the pool 102 may include an outlet 114 at a shallow side (e.g., with the beach 106) and another outlet 114 at the deep side 110. In such embodiments, a user may indicate a desired spa mode in the shallow side, and the circulation system 110 may direct the flow of water only to the outlet 114 at the shallow side (e.g., by actuating a valve for the outlet 114 at the deep side and/or as otherwise desired). Other controls for locally heating sub-portions of the pool 102 may be implemented as desired, and the aforementioned examples are for illustrative purposes only.

The pump 118 and the heater 120 may be activated from a base (or other) mode to the spa mode using various techniques as desired. In some embodiments, the user may manually control the pump 118 and/or the heater 120 to be in the spa mode. Additionally, or alternatively, the controller 122 may automatically control the pump 118 and/or the heater 120 to be in the spa mode. In such embodiments, the controller 122 may control the pump 118 and/or the heater 120 to be in the spa mode based on various inputs, such as but not limited to an activation by the user on an application on a user device, a scheduled future use as determined by the controller 122 and/or provided by the user, and/or other inputs or combinations of inputs as desired.

Exemplary concepts or combinations of features of the invention may include:
A. A method of locally heating a sub-portion of a swimming pool or spa, the method comprising:
   i. decreasing a flow of water through a circulation system using a pump; and
   ii. increasing a temperature of water flowing through the circulation system using a heater.
B. A method of establishing a temperature gradient in water of a swimming pool or spa, the method comprising operating a heater at an increased temperature relative to a temperature baseline and operating a filtration pump at a decreased speed relative to a flow baseline.
C. A method of locally heating a sub-portion of a swimming pool or spa, the method comprising receiving an activation signal from a user and changing a mode of a heater and a pump from a base mode to a spa mode, wherein, in the spa mode, the heater heats water of the swimming pool or spa with higher power compared to the base mode and the pump decreases a flow of water compared to the base mode.
D. The method of any preceding or subsequent statement or combination of statements, wherein the sub-portion of the swimming pool or spa comprises an area of the swimming pool or spa comprising a bench, a beach, or stairs.
E. The method of any preceding or subsequent statement or combination of statements, wherein the method comprises controlling outlets proximate to the sub-portion of the swimming pool or spa.
F. The method of any preceding or subsequent statement or combination of statements, further comprising directing the water from the circulation system to the sub-portion of the swimming pool or spa.
G. The method of any preceding or subsequent statement or combination of statements, wherein the heated water at decreased flow is directed to the sub-portion of the swimming pool or spa.
H. A circulation system for a swimming pool or spa, the circulation system comprising an inlet for receiving water from the swimming pool or spa, a heater, a pump, and an outlet, wherein, in a spa mode, the circulation system decreases a flow of water and increases a temperature of the water.
I. The circulation system of any preceding or subsequent statement or combination of statements, wherein the outlet directs water from the circulation system to the swimming pool or spa.
J. The circulation system of any preceding or subsequent statement or combination of statements, wherein the outlet directs water from the circulation system to a sub-portion of the swimming pool or spa.
K. The circulation system of any preceding or subsequent statement or combination of statements, wherein the circulation system comprises at least one valve to direct the water to the sub-portion of the swimming pool or spa.
L. The circulation system of any preceding or subsequent statement or combination of statements, further comprising a controller communicatively coupled to the pump and the heater for controlling operation of the pump and the heater.
M. The circulation system of any preceding or subsequent statement or combination of statements, wherein the controller is configured to control the circulation system in the spa mode responsive to input from a user.
N. The circulation system of any preceding or subsequent statement or combination of statements, wherein the controller is configured to decrease the flow of water by controlling the pump and is configured to increase the temperature of the water by controlling the heater.
O. The circulation system of any preceding or subsequent statement or combination of statements, wherein the controller is further configured to control the outlet.
P. The circulation system of any preceding or subsequent statement or combination of statements, wherein the controller is configured to control the circulation system such that, in the spa mode, the heater heats water of the swimming pool or spa with higher power compared to a base mode and the pump decreases a flow of water compared to a base mode.
Q. A non-transitory computer readable storage medium comprising a plurality of instructions executable by one or more processors, which, when executed on the one or more processors, cause the one or more processors to perform actions including locally heating a sub-portion of a swimming pool or spa.
R. A non-transitory computer readable storage medium comprising a plurality of instructions executable by one or more processors, which, when executed on the one or more processors, cause the one or more processors to perform actions including establishing a temperature gradient in water of a swimming pool or spa.
S. A non-transitory computer readable storage medium comprising a plurality of instructions executable by one or more processors, which, when executed on the one or more processors, cause the one or more processors to perform actions including receiving an activation signal from a user and changing a mode of a heater and a pump from a base mode to a spa mode, wherein, in the spa mode, the heater heats water of the swimming pool or spa with higher power compared to the base mode and the pump decreases a flow of water compared to the base mode.
T. The non-transitory computer readable storage medium of any preceding or subsequent statement or combination of statements, wherein the instructions comprise instructions to perform the method of any preceding or subsequent statement or combination of statements.

These examples are not intended to be mutually exclusive, exhaustive, or restrictive in any way, and the invention is not limited to these example embodiments but rather encompasses all possible modifications and variations within the scope of any claims ultimately drafted and issued in connection with the invention (and their equivalents). For avoidance of doubt, any combination of features not physically impossible or expressly identified as non-combinable herein may be within the scope of the invention. Further, although applicant has described devices and techniques for use principally with swimming pools and spas, persons skilled in the relevant field will recognize that the present invention conceivably could be employed in connection with other objects and in other manners. Finally, references to “pools” and “swimming pools” herein may also refer to spas or other water containing vessels used for recreation, training, or therapy.

That which is claimed:

1. A method of locally heating a sub-portion of a swimming pool or spa, the method comprising operating a pump and a heater in a spa mode by:
decreasing a flow of water through a circulation system using a pump; and
increasing a temperature of water flowing through the circulation system using a heater.

2. The method of claim 1, further comprising receiving an activation signal from a user and changing a mode of the heater and the pump from a base mode to the spa mode, wherein, in the spa mode, the heater heats water of the swimming pool or spa with higher power compared to the base mode and the pump decreases a flow of water compared to the base mode.

3. The method claim 1, wherein the sub-portion of the swimming pool or spa comprises an area of the swimming pool or spa comprising a bench, a beach, or stairs.

4. The method of claim 1, further comprising controlling outlets proximate to the sub-portion of the swimming pool or spa.

5. The method of claim 1, further comprising directing the water from the circulation system to the sub-portion of the swimming pool or spa.

6. The method of claim 1, wherein the heated water at decreased flow is directed to the sub-portion of the swimming pool or spa.

7. A method of establishing a temperature gradient in water of a swimming pool or spa, the method comprising operating a heater at an increased temperature relative to a temperature baseline and operating a filtration pump at a decreased speed relative to a flow baseline.

8. The method of claim 7, wherein operating the heater at the increased temperature and the filtration pump at the decreased speed is responsive to a user input.

9. The method of claim 7, wherein establishing the temperature gradient comprises heating a sub-portion of the swimming pool relative to another portion of the swimming pool.

10. The method of claim 9, wherein the sub-portion of the swimming pool or spa comprises an area of the swimming pool or spa comprising a bench, a beach, or stairs.

11. The method of claim 7, further comprising controlling outlets of a circulation system directing water into the swimming pool or spa.

12. A circulation system for a swimming pool or spa, the circulation system comprising:
an inlet for receiving water from the swimming pool or spa;
a heater;
a pump; and
an outlet,
wherein, in a spa mode, the circulation system decreases a flow of water and increases a temperature of the water.

13. The circulation system of claim 12, wherein the outlet directs water from the circulation system to the swimming pool or spa.

14. The circulation system of claim 12, wherein the outlet directs water from the circulation system to a sub-portion of the swimming pool or spa.

15. The circulation system of claim 12, further comprising at least one valve to direct the water to the sub-portion of the swimming pool or spa.

16. The circulation system of claim 12, further comprising a controller communicatively coupled to the pump and the heater for controlling operation of the pump and the heater.

17. The circulation system of claim 16, wherein the controller is configured to control the circulation system in the spa mode responsive to input from a user.

18. The circulation system of claim 16, wherein the controller is configured to decrease the flow of water by controlling the pump and is configured to increase the temperature of the water by controlling the heater.

19. The circulation system of claim 16, wherein the controller is further configured to control the outlet.

20. The circulation system of claim 16, wherein the controller is configured to control the circulation system such that, in the spa mode, the heater heats water of the swimming pool or spa with higher power compared to a base mode and the pump decreases a flow of water compared to a base mode.
